(19) United States
(12) Patent Application Publication
(10) Pub. No.: US 2008/0129820 A1
(43) Pub. Date: Jun. 5, 2008

(54) TV system capable of recording multimedia audiovisual program

(75) Inventors: Yu-Chuan Chang, Taipei (TW); Yi-Hsin Hsieh, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei City (TW)

(21) Appl. No.: 11/633,249

(22) Filed: Dec. 4, 2006

(51) Int. Cl. H04N 7/18

(52) U.S. Cl. 348/61; 348/E07.085

(57) ABSTRACT

A TV system capable of recording a multimedia audiovisual program is provided, which comprises a first TV apparatus for receiving a TV audiovisual signal and displaying a corresponding audiovisual program; and a portable second TV apparatus with a built-in storage unit, which is electrically connected to the first TV apparatus and receives a record actuating signal in order to synchronically record the audiovisual program to the storage unit. A user watches the audiovisual program through the second TV apparatus when the second TV apparatus is separated from the first TV apparatus, thereby enhancing the convenience of using the TV apparatus.

### BACKGROUND OF THE INVENTION

1. Field of Invention

The present invention relates to a TV apparatus, and more particularly, to a TV system capable of recording a multimedia audiovisual program.

2. Related Art

With the advent of the multimedia era, watching TV has become necessary entertainment in modem people's daily life. Especially with a TV with the function of picture-in-picture, in which a TV screen is further divided into more than two frames playing TV programs of different channels, users are provided with more visual enjoyment. However, people may often have no time to watch some live TV programs, such as ball games, and feel regretful, so people have to set a recording procedure in advance to record TV programs they want to watch later. And, if other necessary matters need to be dealt with outside, the user will have to give up the program which has been playing for a time, which is extremely regrettable.

Taiwan Patent No. M249386 discloses a portable audiovisual player, which at least comprises an upper housing and a lower housing, a display unit, a media player, a control circuit, a wireless receiver module, an audio output unit, at least one button, a card reader, and batteries. After the components are combined, the portable audiovisual player may be carried about, and used to receive a wireless signal in a wireless manner or play the audiovisual data in the media.

Though a user may carry the player to watch media audiovisual data, the player is not perfect in usage for it cannot be used to record TV programs synchronically.

Taiwan Patent No. M268843 discloses a modulized audiovisual apparatus. The modulized audiovisual apparatus comprises a portable signal process device which further comprises a processor, an audiovisual input terminal electrically connected to the processor, an audiovisual output terminal electrically connected to the processor, a loudspeaker electrically connected to the audiovisual output terminal, and a first connector fixed on the signal process device and electrically connected to the audiovisual output terminal. The modulized audiovisual apparatus further comprises a display. The display further comprises a second connector fixed on the display to be electrically connected to the first connector directly, wherein the signal process device is supported on the display through coupling the second connector to the first connector.

Though the audiovisual apparatus is portable and the components may be upgraded respectively, the audiovisual apparatus is still not perfect for it cannot be used to record TV programs synchronically, either.

Therefore, it has become a problem to be solved for researchers how to provide a TV system capable of recording a multimedia audiovisual program, wherein with such TV system, a recorded audiovisual program may be watched anywhere, thereby enhancing the convenience of using a TV apparatus.

### SUMMARY OF THE INVENTION

In view of the above problems, one main object of the present invention is to provide a TV system capable of recording a multimedia audiovisual program, which is capable of watching an audiovisual program anywhere through a portable TV apparatus with the function of recording, thereby enhancing the convenience of using the TV apparatus.

Accordingly, in order to achieve the aforementioned object, the TV system capable of recording a multimedia audiovisual program disclosed by the present invention comprises a first TV apparatus for receiving a TV audiovisual signal and playing an audiovisual program; and a portable second TV apparatus with a built-in storage unit, which is electrically connected to the first TV apparatus and receives a record actuating signal in order to synchronically record an audiovisual program in the storage unit. A user watches the audiovisual program through the second TV apparatus when the second TV apparatus is separated from the first TV apparatus.

The first TV apparatus further comprises a tuner for tuning a video signal and an audio signal of the TV audiovisual signal, a first audiovisual signal input/output interface for providing a link interface to transmit the video signal and the audio signal, a first display element for receiving the video signal to realize the video effect, and a first loudspeaker for receiving the audio signal to realize the audio effect.

The second TV apparatus further comprises a second audiovisual signal input/output interface for providing a link interface to transmit the video signal and the audio signal, a second display element for receiving the video signal to realize the video effect, and a second loudspeaker for receiving the audio signal to realize the audio effect.

Through the TV system capable of recording a multimedia audiovisual program, after the portable TV apparatus with the built-in storage media is connected to a large-scale TV apparatus, a user may synchronically record the audiovisual program that cannot be watched immediately in the portable TV apparatus and watch the program through the portable TV apparatus, thereby achieving the object of enhancing the convenience of using a TV apparatus.

The features and practice of the present invention will be illustrated by the preferred embodiments below in detail with the accompanied drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a system block diagram of an embodiment of the present invention.

### DETAILED DESCRIPTION OF THE INVENTION

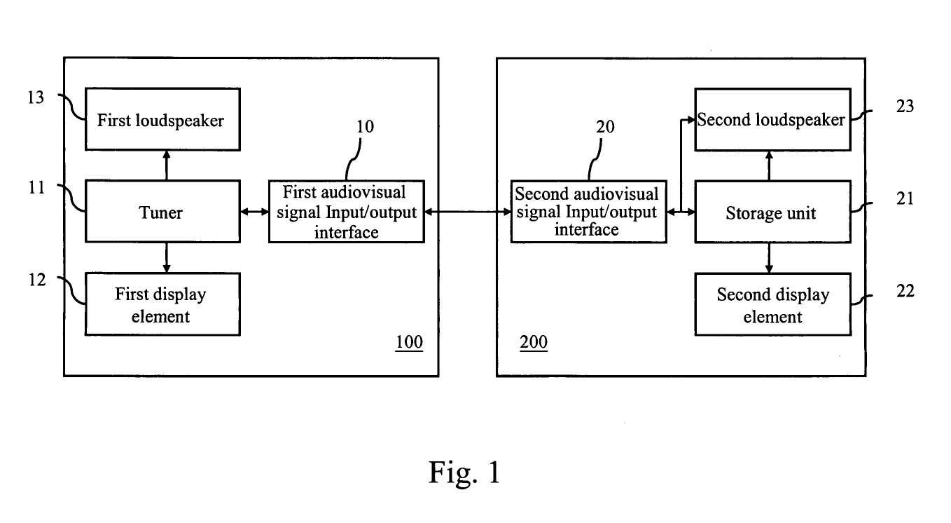

Please refer to FIG. 1 of a system block diagram according to an embodiment of the present invention. As shown in FIG. 1, the TV system of the present invention includes a first TV apparatus 100 and a second TV apparatus 200. The first TV apparatus 100 is used to receive a TV audiovisual signal and play an audiovisual program corresponding to the TV audiovisual signal, and the second TV apparatus 200 is electrically connected to the first TV apparatus 100 for receiving a record actuating signal, thereby synchronically recording the audiovisual program displayed in the first TV apparatus 100.

The first TV apparatus 100 includes a first audiovisual signal input/output interface 10, a tuner 11, a first display element 12, and a first loudspeaker 13.

The tuner 11 is used to receive the TV audiovisual signal through an antenna or a cable, thereby tuning the video signal and the audio signal in the TV audiovisual signal. The first audiovisual signal input/output interface 10 electrically connected to the tuner 11 has various video and audio link interfaces, such as a digital optical fiber input terminal, an audio/video (AV) input terminal, and an audio/super-video input terminal, in order to provide a link interface required for transmitting video signals and audio signals to the second TV apparatus 200.

The first display element 12 is electrically connected to the tuner 11 for receiving the video signals, thereby realizing the corresponding video effect of the first TV apparatus 100. In the embodiment of the present invention, the first display element 12 can be a Plasma Display Panel (PDP), a liquid crystal display (LCD), an Organic Electro-Luminescent Display (OLED, PLED), a vacuum screen display (VFD), or a field emission display (FED), etc.

Furthermore, the first loudspeaker 13 is electrically connected to the tuner 11 for receiving the audio signals, thereby realizing the corresponding audio effect of the first TV apparatus 100. In the embodiment of the present invention, the first loudspeaker 13 can be a speaker or an earphone.

The second TV apparatus 200 includes a second audiovisual signal input/output interface 20, a storage unit 21, a second display element 22, and a second loudspeaker 23.

The second audiovisual signal input/output interface 20 has various video and audio link interfaces, such as a digital optical fiber input terminal, an audio/video (AV) input terminal, and an audio/super-video input terminal, in order to provide a link interface required for transmitting the video signals and the audio signals with the first audiovisual signal input/output interface 10.

The storage unit 21 is built in the second TV apparatus 200 and electrically connected to the second audiovisual signal input/output interface 20. The storage unit 21 is triggered by the record actuating signal to synchronically record the audiovisual program while receiving audio/video signals from the second audiovisual signal input/output interface 20. In the embodiment of the present invention, the storage unit 21 can be a storage media, such as a flash memory, a micro hard disk, or an optical storage media.

The second display element 22 is electrically connected to the storage unit 21 for receiving the video signals, thereby realizing the corresponding video effect of the second TV apparatus 200. In the embodiment of the present invention, the second display element 22 can be a liquid crystal display, an Organic Electro-Luminescent Display (OLED, PLED), or a micro display, etc.

Furthermore, the second loudspeaker 23 is electrically connected to the storage unit 21 for receiving the audio signals, thereby realizing the corresponding audio effect of the second TV apparatus 200. In the embodiment of the present invention, the second loudspeaker 23 can be a speaker or an earphone.

As above-mentioned, when the second TV apparatus 200 is electrically connected to the first TV apparatus 100, the video and the audio signals generated from the tuner 11 of the first TV apparatus 100 are transmitted into the second audiovisual signal input/output interface 20 through the first audiovisual signal input/output interface 10, and then stored in the storage unit 21. Obviously, even though the second TV apparatus 200 is separated from the first TV apparatus 100, the video and the audio signals stored in the storage unit 21 are realized to display the corresponding video and audio effect via the second display element 22 and the second loudspeaker 23, respectively.

In comparison with the prior art, the TV system of the present invention is capable of recording a multimedia audiovisual program, after a portable TV apparatus with the built-in storage media is connected to a large-scale TV apparatus, a user may synchronically record the audiovisual program that cannot be watched immediately into the portable TV apparatus and watch the program through the portable TV apparatus, thereby achieving the object of enhancing the convenience of using a TV apparatus.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A TV system capable of recording a multimedia audiovisual program, comprising:
a first TV apparatus for receiving a TV audiovisual signal and playing an audiovisual program; and
a portable second TV apparatus with a built-in storage unit and electrically connected to the first TV apparatus, which is used for receiving a record actuating signal, thereby synchronically recording the audiovisual program into the storage unit;
wherein a user watches the audiovisual program through the second TV apparatus when the second TV apparatus is separated from the first TV apparatus.

2. The TV system capable of recording a multimedia audiovisual program as claimed in claim 1, wherein the first TV apparatus further comprises:
a tuner for tuning a video signal and an audio signal in the TV audiovisual signal;
a first audiovisual signal input/output interface for providing a link interface to transmit the video signal and the audio signal;
a first display element for receiving the video signal to realize a video effect; and
a first loudspeaker for receiving the audio signal to realize an audio effect.

3. The TV system capable of recording a multimedia audiovisual program as claimed in claim 2, wherein the first audiovisual signal input/output interface is one selected from the group consisting of a digital optical fiber input terminal, an audio/video (AV) input terminal, and an audio/super-video input terminal.

4. The TV system capable of recording a multimedia audiovisual program as claimed in claim 2, wherein the first display element is one selected form of the group consisting of a Plasma Display Panel (PDP), a liquid crystal display (LCD), an Organic Electro-Luminescent Display (OLED, PLED), a vacuum screen display (VFD), and a field emission display (FED).

5. The TV system capable of recording a multimedia audiovisual program as claimed in claim 2, wherein the second TV apparatus further comprises:
a second audiovisual signal input/output interface for providing a link interface to transmit the video signal and the audio signal;
a second display element for receiving the video signal to realize a video effect; and
a second loudspeaker for receiving the audio signal to realize an audio effect.

6. The TV system capable of recording a multimedia audiovisual program as claimed in claim 5, wherein the second audiovisual signal input/output interface is one selected from the group consisting of a digital optical fiber input terminal, an audio/video (AV) input terminal, and an audio/super-video input terminal.

7. The TV system capable of recording a multimedia audiovisual program as claimed in claim 5, wherein the second display element is one selected form the group consisting of a liquid crystal display (LCD), an Organic Electro-Luminescent Display (OLED, PLED), and a micro display.
